(19) United States
(12) Patent Application Publication
(10) Pub. No.: US 2017/0116627 A1
(43) Pub. Date: Apr. 27, 2017

(54) CROWD-SOURCED POLLING & SHARING

(71) Applicant: 1World Online, Inc., San Jose, CA (US)

(72) Inventors: Alexei FEDOSSEEV, San Jose, CA (US); Sergey CHERNOGORODSKIY, Moscow (RU); Damien LEOSTIC, San Jose, CA (US)

(21) Appl. No.: 14/920,609

(22) Filed: Oct. 22, 2015

(51) Int. Cl. G06Q 30/02; H04L 12/58; G06Q 50/00; G07C 13/00

(52) U.S. Cl. CPC G06Q 30/0203; G07C 13/00; H04L 51/32; G06Q 50/01

(57) ABSTRACT

Techniques for including and sharing crowd-sourced questions in online polls include a method with the steps of, in response to a client request for content, selecting from a repository of poll questions at least one poll question associated with the requested content and providing to the requesting client the requested content and a poll allowing a user to respond to the at least one selected question; receiving from the client a poll question generated by the user, the poll question including at least a question associated with the content and a plurality of answers responsive to the question; storing the received user-generated question in the repository of poll questions; and, in response to a subsequent request by a different client for the same content, selecting the user-generated question and providing to the different requesting client the requested content and a poll including the user-generated question.

### TECHNICAL FIELD

This application relates generally to online polling, and more specifically to user-generated polling questions.

### BACKGROUND OF THE INVENTION

Within Internet and online venues and digital properties, what are known to many as Web 2.0 and Big Data services, we are now transitioning to a new level of understanding that information built and shared via social and professional networks needs to be more credible and representative in order to be useful. In particular, there is unmet demand to obtain accurate, quantifiable and comprehensive data on what people really think about various topics in their life and issues in their world. As an example, to optimally plan development and sales for any product or service it is imperative for merchandisers and marketers to best understand customers' views on product features, service appeal, trends, pricing, as well as have reliable, measurable insight into consumer interests and their decision-making processes. The same is true for analysts in every other area of human life, including politics, culture, sports, entertainment, estimates of geographical, educational and vocational trends, etc.

Traditional analysis relies on the content provider or a third-party poll provider to determine which questions to ask users. This runs the risk of “missing the mark” if the questions asked do not best reflect user interests and concerns. A need therefore exists to provide a way of generating poll questions that better reflect users' viewpoints and can harness the “wisdom of the crowd.”

### SUMMARY OF THE INVENTION

The present invention relates to a method and system to allow for users to provide, not only responses to existing poll questions, but also new poll questions. These poll questions may be made available to other users on a question generator's network, and may also be made available to the content or poll provider for broader distribution.

In one embodiment, the techniques may be realized as a method comprising the steps of, in response to a client request for content, selecting from a repository of poll questions at least one poll question associated with the requested content and providing to the requesting client the requested content and a poll allowing a user to respond to the at least one selected question; receiving from the client a poll question generated by the user, the poll question including at least a question associated with the content and a plurality of answers responsive to the question; storing the received user-generated question in the repository of poll questions; and, in response to a subsequent request by a different client for the same content, selecting the user-generated question and providing to the different requesting client the requested content and a poll including the user-generated question.

In accordance with other aspects of this embodiment, the method may further include receiving from the user permission for the user-generated question to be published; submitting to a provider associated with the content the user-generated question; and receiving from the provider approval to associated the user-generated question with the content in the repository; wherein the user-generated question is provided to the different client based on it being associated with the content in the repository.

In accordance with other aspects of this embodiment, the method may further include providing to the client a reference uniquely designating the user-generated question. The user-generated question can be provided to the different client based on the client providing the reference as part of the request for the content.

In accordance with further aspects of this embodiment, the method may further include, before providing the user-generated question, determining that the different client is associated with a different user that is connected on a social network to the user that generated the question.

In accordance with other aspects of this embodiment, the method may further include, before providing the user-generated question, determining that the different client associated with a different user that is connected on a social network to the user that generated the question; and providing the identity of the user that generated the question to the different client.

In accordance with other aspects of this embodiment, the method may further include providing, along with the poll provided to the client, a reference to a form for submitting a poll question associated with the content. The user-generated poll question can be received from the user selecting the reference and completing the form

In accordance with another embodiment, the techniques may be realized as an article of manufacture including at least one processor readable storage medium and instructions stored on the at least one medium. The instructions may be configured to be readable from the at least one medium by at least one processor and thereby cause the at least one processor to operate so as to carry out any and all of the steps in the above-described method.

In accordance with another embodiment, the techniques may be realized as a system comprising one or more processors communicatively coupled to a network; wherein the one or more processors are configured to carry out any and all of the steps described with respect to any of the above embodiments.

The present disclosure will now be described in more detail with reference to particular embodiments thereof as shown in the accompanying drawings. While the present disclosure is described below with reference to particular embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

### BRIEF DESCRIPTION OF THE DRAWINGS

Better understanding of the present invention may be obtained by reference to the accompanying drawings, when considered in conjunction with the subsequent, detailed description.

FIG. 1 is an illustrative screen shot of a content page in accordance with implementations of the present invention.

FIG. 1A is an illustrative screen shot of a poll question on the content page of FIG. 1 in accordance with implementations of the present invention.

FIG. 2A is an illustrative screen shot of a login screen for a user-generated poll question form in accordance with implementations of the present invention.

FIG. 2B is an illustrative screen shot of a user-generated poll question form in accordance with implementations of the present invention.

FIG. 2C is an illustrative screen shot of a user-generated poll question form in accordance with implementations of the present invention.

FIG. 2D is an illustrative screen shot of a confirmation page for a user-generated poll question form in accordance with implementations of the present invention.

FIG. 3 is an illustrative screen shot of a social network window for sharing content and a user-generated poll question in accordance with implementations of the present invention.

FIG. 4 is an illustrative screen shot of a polling dashboard including user-generated poll questions in accordance with implementations of the present invention.

FIG. 5A is an illustrative screen shot displaying the results of a user-generated poll question with breakdown by demographic parameters in accordance with implementations of the present invention.

FIG. 5B is an illustrative screen shot displaying the results of a user-generated poll question listing responses by social network contacts in accordance with implementations of the present invention.

FIG. 6 is a flowchart illustrating a method for receiving and managing a user-generated poll question in accordance with implementations of the present invention.

FIG. 7 is a block diagram showing systems associated with serving content and polls and managing user-generated poll questions in accordance with implementations of the present invention.

FIG. 8 illustrates a data structure for a user-generated poll question within a repository in accordance with implementations of the present invention.

### DETAILED DESCRIPTION

The present invention relates to a method and system to allow for content users to generate their own poll questions associated with particular internet content. The system allows the user to spread their own poll questions to members of their social network as well as submitting the question to be included more generally on the content provider's site.

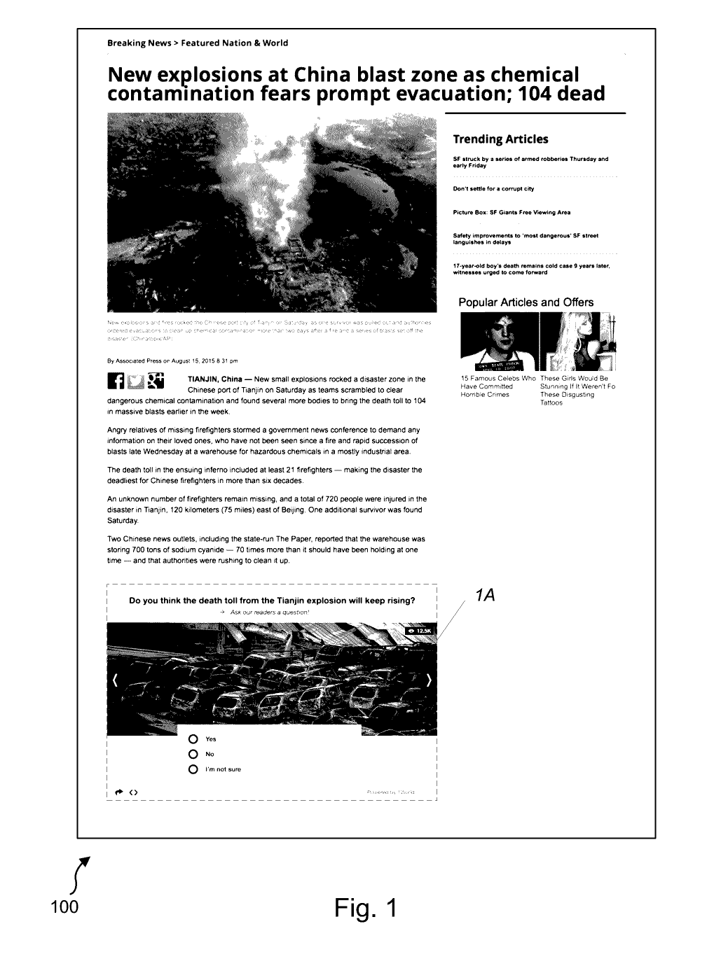

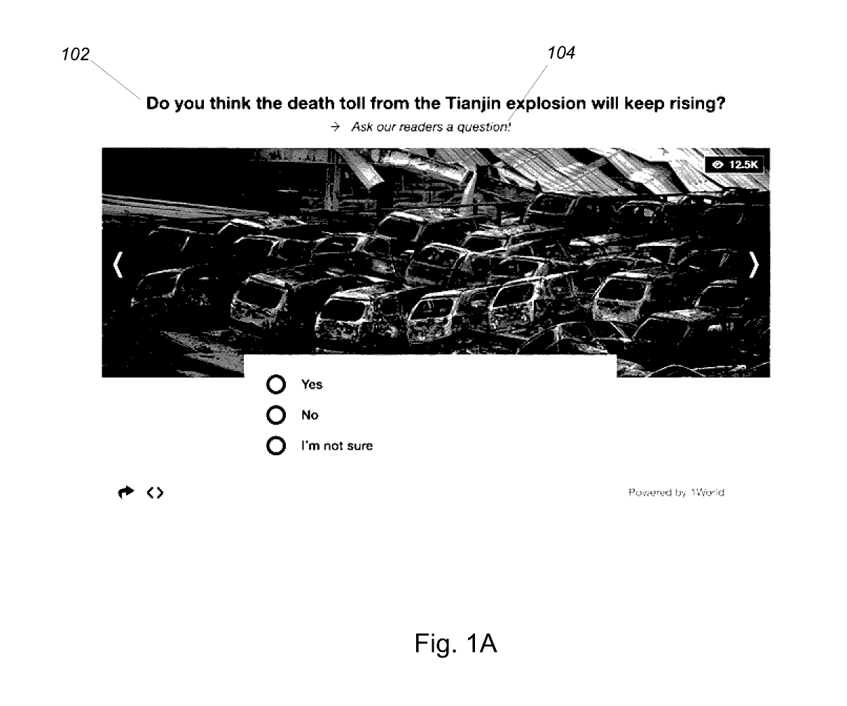

FIG. 1 shows a screenshot of an exemplary content page 100 with a poll question shown thereon as outlined by section 1A. The poll question 102 is shown more clearly in FIG. 1A. In addition to providing a question with answers from which a user can select, the poll question 102 also provides a link 104 that, when selected, allows a user to generate their own poll question.

In some implementations, the link 104 may appear only selectively to some viewers of the content page 100. A server managing a poll widget disposed within the section 1A of the page 100 may selectively provide the link 104 to some users based, for instance, on demographic data which show particular users to be good candidates for value-added questions. For example, users known to be well-positioned in social networks, users with a history of viewing articles associated with the topic of the content page 100, or users already engaged with polling systems may be selected. Some implementations may include the link 104 for all users or for a random selection of users.

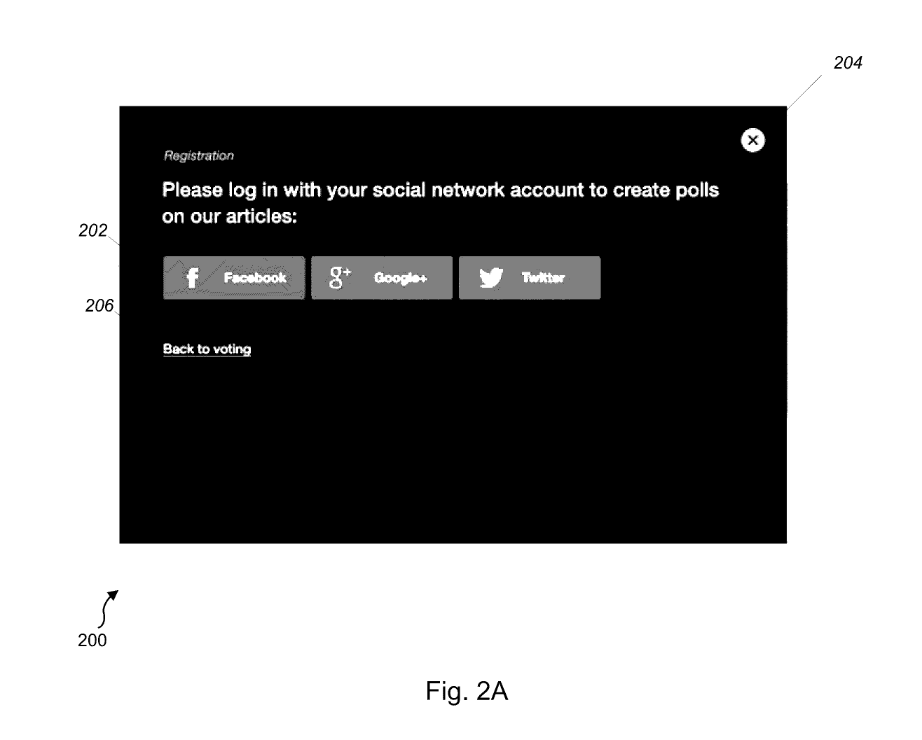

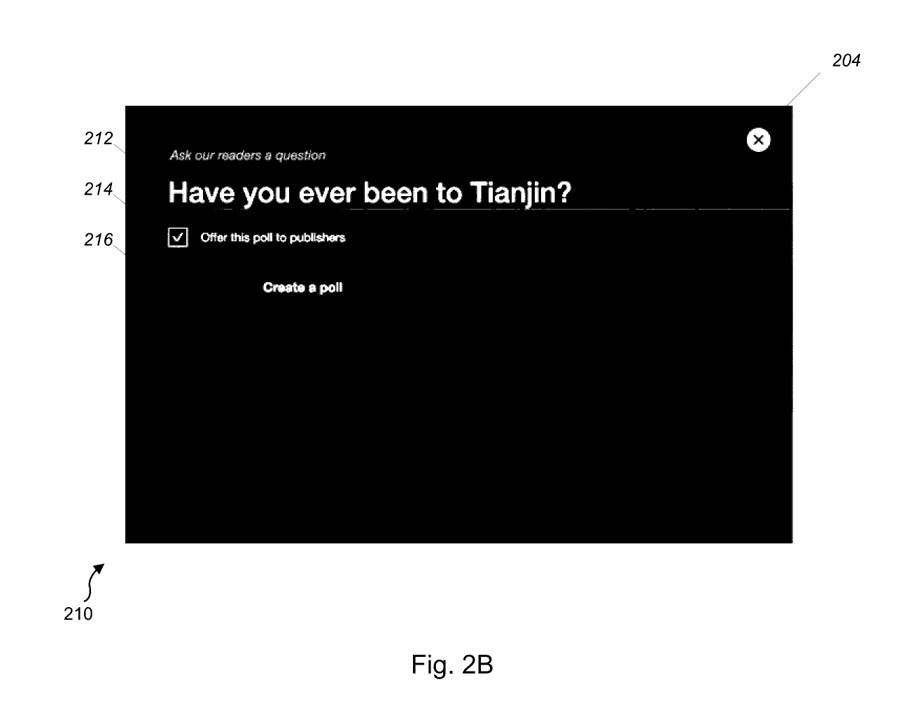

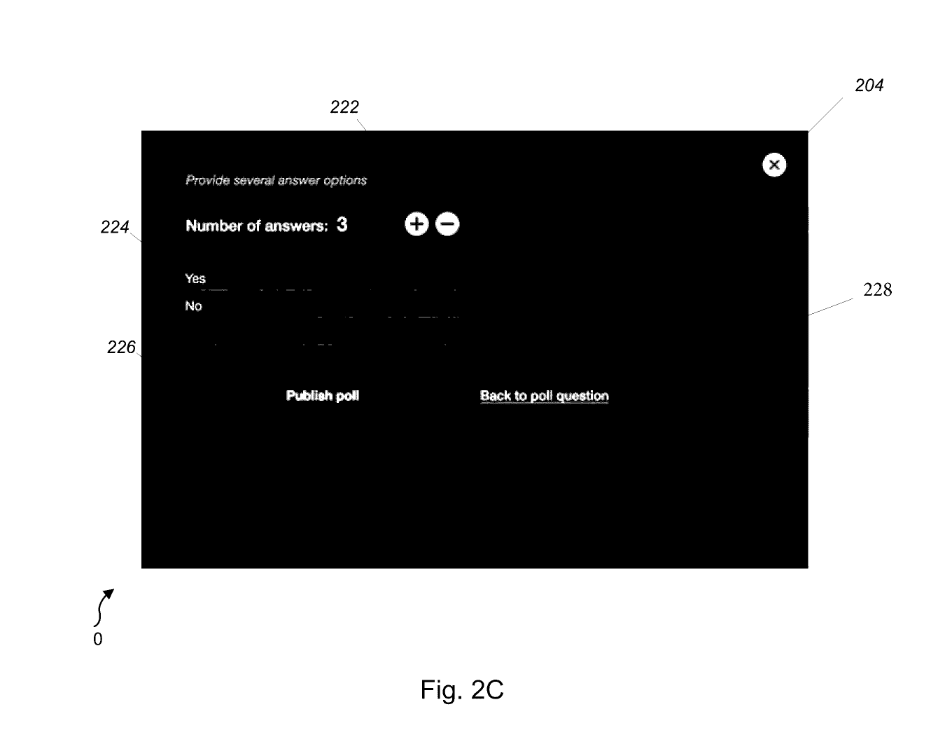

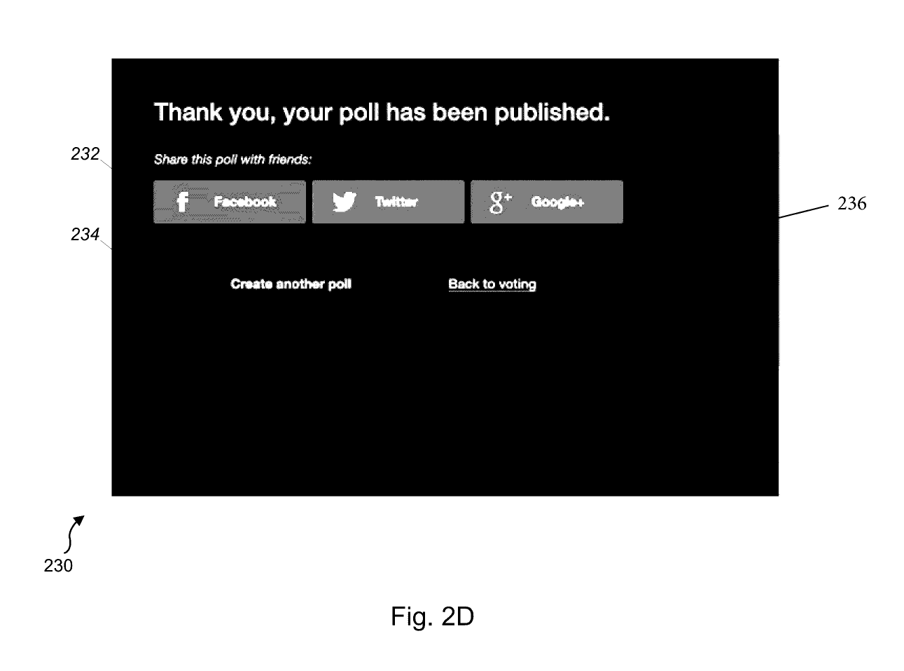

Upon selecting the link 104, a user may be taken to a series of windows which allow the user to create a custom poll question as illustrated in FIGS. 2A-D. In some implementations, the windows as shown may be disposed in the exemplary content page 100 such that the browser does not load a whole new page in order to complete the polling process but instead simply replaces the content within the outline 1A as shown in FIG. 1.

First, if the user is not registered, a registration page 200 may be provided as shown in FIG. 2A. A plurality of login options 202 may be provided, each associated with an existing social network. At any time during this process, a user can select the cancellation icon 204 to cancel the poll creation screens and return to the poll; options such as link 206 on window 200 can provide the same choice.

Once the user is registered and logged in, a question creation screen 210 shown in FIG. 2B prompts the user to create a custom question entered into the test box 212. The user can then make a selection via the checkbox 214 as to whether this question should be made available to the content publishers. Selecting the button 216 generates a poll and leads to the display of screen 220 as shown in FIG. 2C.

Screen 220 allows for the user to input poll answers. As shown, the user can choose the number of actors with the buttons 222 and then enter the answers themselves into text entry boxes 224. Selecting the button 226 publishes the poll; we are again given a link 228 that will cancel the custom poll generation and return the user to published poll question instead.

In some implementations, default answers may be made available to users such that they can choose from available answers rather than having to type them in by default. Default answers may be populated automatically based on the most common answers in related polls (“yes,” “no,” “agree” “disagree,” “no opinion,” etc.).

Once the user submits answers and publishes the poll, a window 230 as shown in FIG. 2D may provide the user the opportunity to share the poll with friends via selection of one or more social media site buttons 232, or to create another poll via button 234. A link 236 may again eliminate the supplemental content within the outline 1A and return the user to the original content page 100.

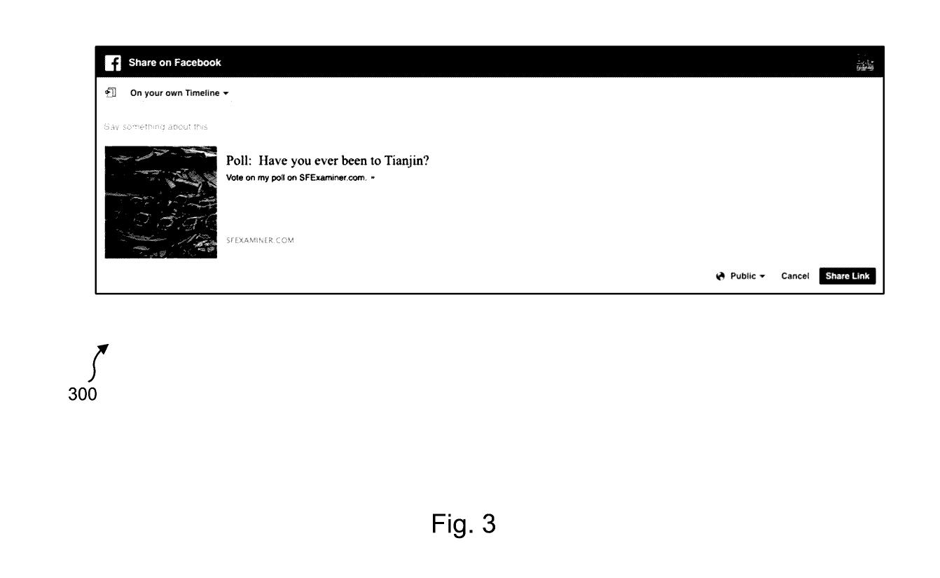

If the user chooses to share the poll with friends, such as by selecting one of the social media site buttons 232 shown in the window 230, the system may connect with the user's social media account in one of a number of ways known in the art. The system may, for example, have an associated application or platform within the social media website which allows it to publish on the user's account and share data with the user's friends given the user's permission. FIG. 3 shows an example of a window 300 that may be provided to a user to allow the user to share the created poll with friends on social media.

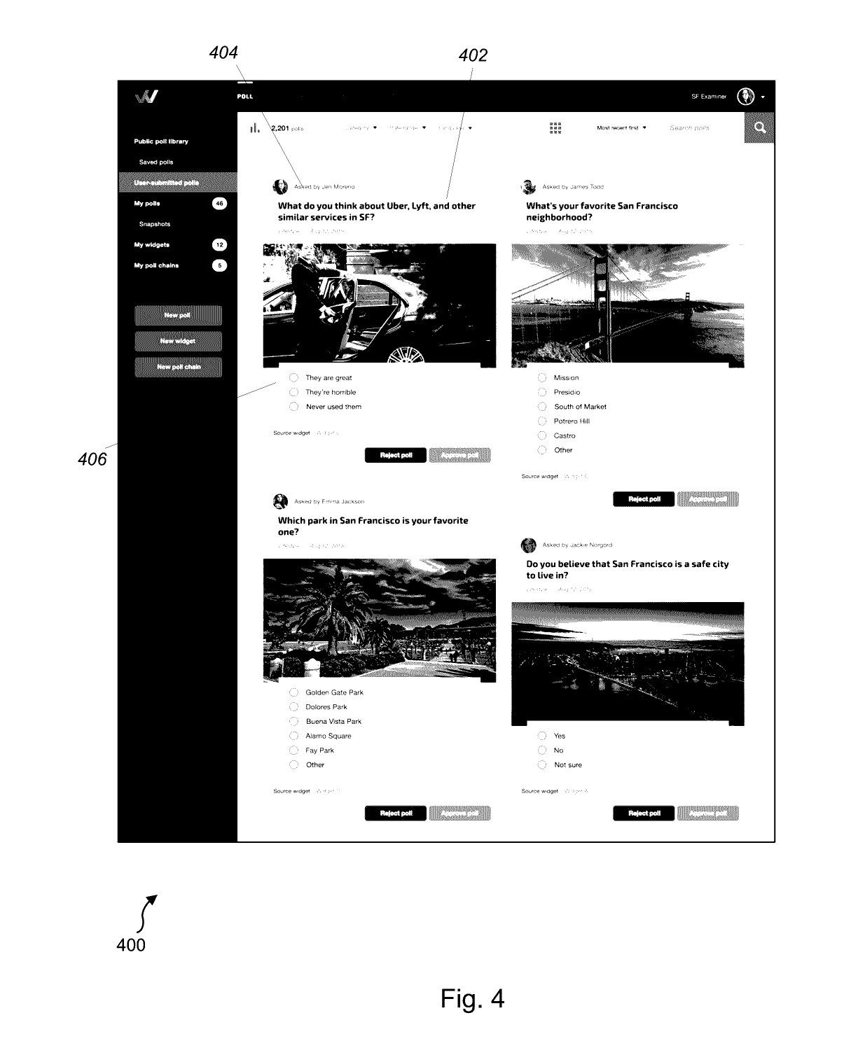

FIG. 4 shows a content provider's dashboard screen 400 which shows the results of user submissions of poll questions. Each poll question 402 is submitted along with the user 404 that submitted it and a provided set of poll answers 406. In some implementations, the content publisher can allow any of the submitted poll questions to be added to the appropriate poll where anyone viewing the content may see the question, similar to any other question submitted by the content publisher for the poll.

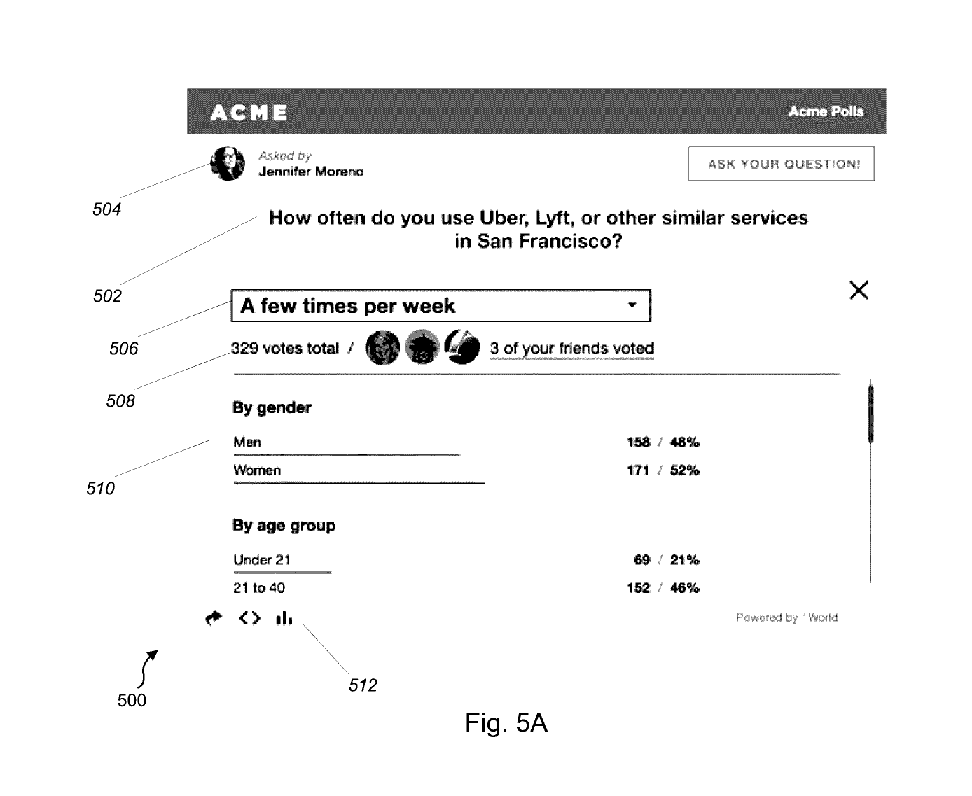

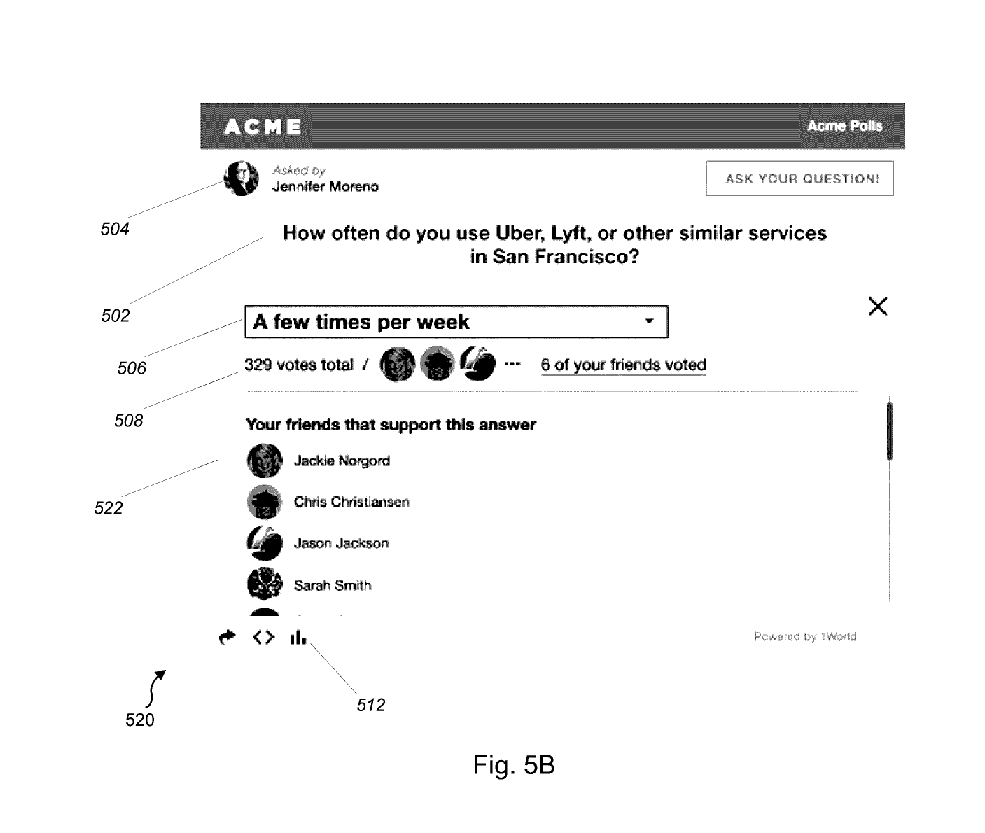

FIG. 5A shows an illustration of a results page 500 including a question 502 asked by a user 504. Here, for a particular response selected at a dropbox 506, respondents 508 are shown including both the total public response and a list of friends who responded according to the selected response (displayed here as a list of selectable icons). The page 500 shows a demographic breakdown 510 of all public respondents. As shown in FIG. 5B, a page 520 may (in place of public demographic data) show a detailed list 522, including names, of friends who responded according to the selected response. Navigation buttons 512 on both pages 500 and 520 may allow a user to access additional data about the public response as well as additional data about friend responses.

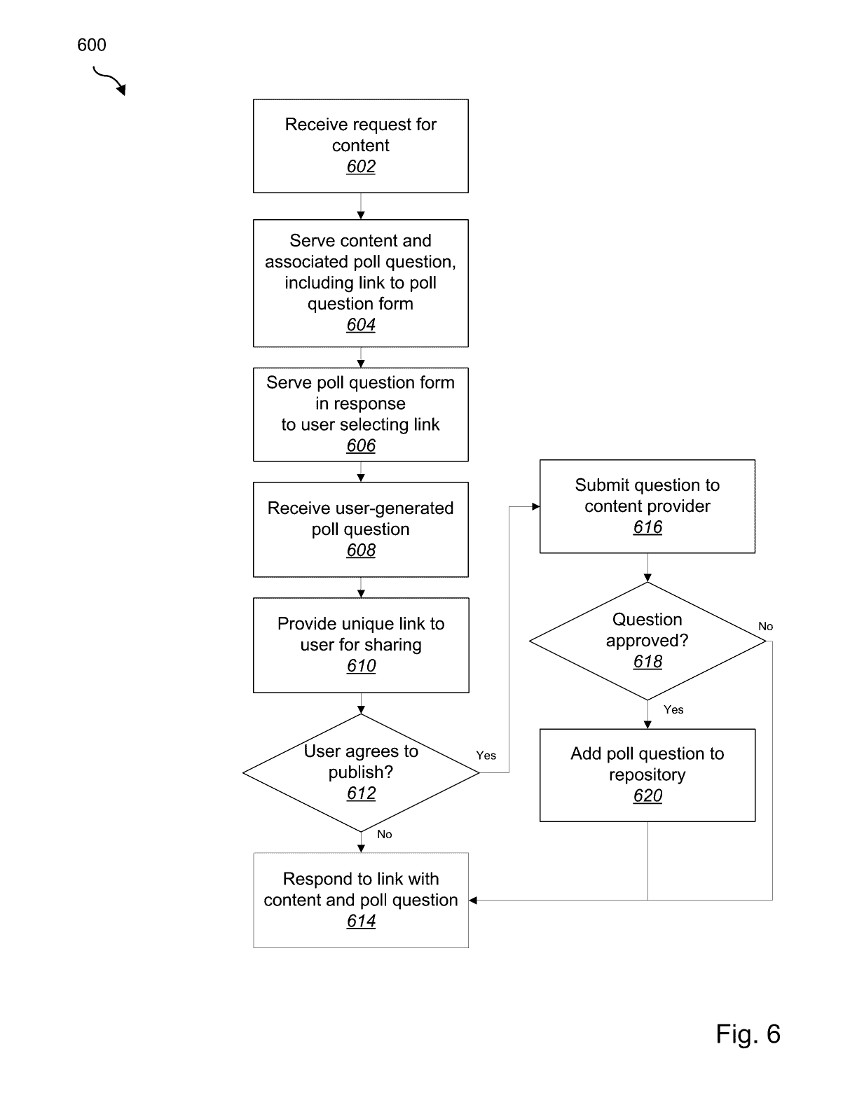

FIG. 6 is a flowchart illustrating an exemplary method 600 for publishing crowd-sourced poll questions in accordance with embodiments of the present invention. In some implementations, the steps as illustrated may be carried out by components of a poll management system which are discussed herein as a “poll server.” One of ordinary skill will recognize that various systems in conjunction with non-transitory media can embody systems capable of carrying out steps as described.

Steps as described may be performed in response to a request for content (602). This could include, for example, a web client request for a web page such as the content page illustrated with respect to FIG. 1 above. Content may also be associated with specialized applications, with broadcast media such as video or audio systems, or the like.

Regardless of the nature of the content, the content provider has included an opportunity for a poll associated with the content to be included along with the content. This poll may be in the form of a pop-up window, a widget, an optional notification, or any other appropriate means. The system serves both the requested content, and at least one poll question associated with the content, to the requesting client (604). In addition to the poll question, the system also includes a link that directs the user to a form for creating a custom poll question relevant to the same content.

In response to a user selecting the “create your own question” link, the system serves the poll question form (606). As illustrated above with respect to FIGS. 1-2D, in some implementations, the poll question form may be displayed as a window in place of the originally-served poll question. In other implementations, serving the poll question form may involve an additional window or display.

When the user fills out and submits the form, the system receives the data for a user-generated poll question 608. The form can include the option as to whether the user wishes to allow the publisher to include the poll question for display to other readers (that is, “publish” the question).

The user-generated poll question may be associated with a unique ID which can be converted to a URL and given to the user for sharing on social media (610). The URL may be, for instance, the URL associated with the original content page with an additional string added to identify the specific user-generated poll.

In some implementations, the system may respond to any use of the link that includes the additional string by including the user-generated poll question with the requested content (614). In other implementations, where the user has not agreed to publish the question for wider use (“No” branch of 612), some security may be included such that only those identified as connected to the user on a social network can see and answer the poll question.

If the user does agree to publish the question (“Yes” branch of 612), the system may then hold the question for approval by the content provider (616). Although the exemplary implementation conflates the provider of the content with the management of the polls, it will be understood that in some implementations webpage or other content may be managed separately from the poll questions that appear along with the content.

If the content provider approves the question for publication (“Yes” branch of 618), then the poll question may be associated with the content and added to the general poll question repository as a potential selection whenever the content is requested (620). If the user-generated poll question is not approved by the content provider (“No” branch of 618), then in some implementations only those who receive the specific link provided to the user will see the user-generated question. This allows both the user and the content provider to decide whether a particular user-generated question will end up before a wider public audience in association with certain content.

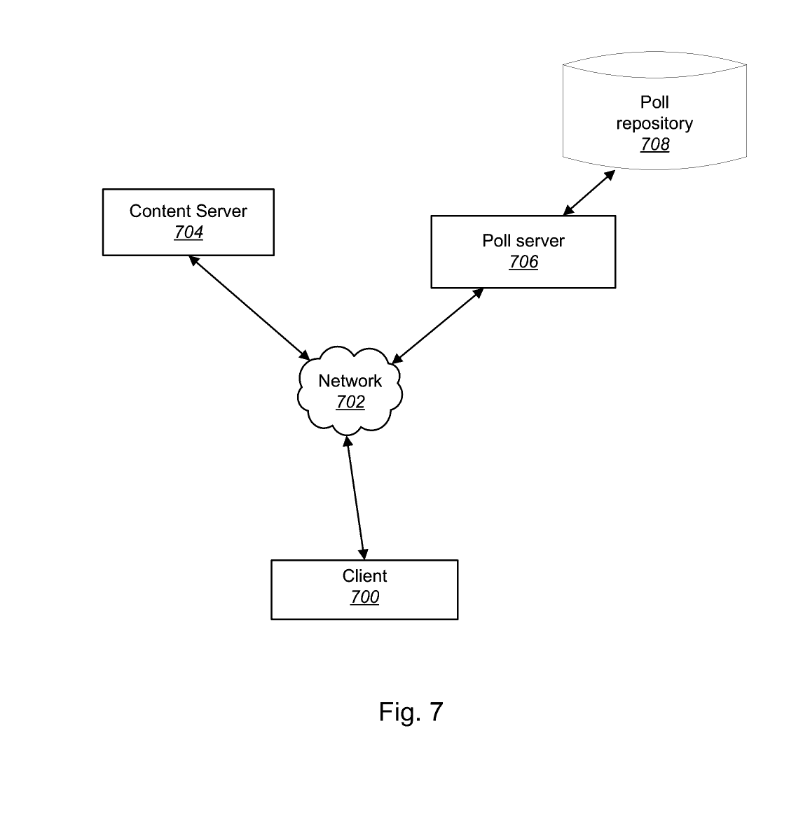

FIG. 7 shows a block diagram with components according to some embodiments of the present invention. A client device 700 is connected to a network 702 which may be, for example, the Internet. The client device 700 sends a request for a webpage, which is managed by a content server 704. The content server 704 in turn communicates with a poll server 706, which in turn manages poll data from a poll repository 708.

In some implementations, the content server 704 may be responsible for supplying the majority of the content of a webpage such as the content page 100 shown in FIG. 1, while the poll server 706 is in turn responsible for the content within the area 1A shown in FIG. 1 (which may be standardized in the building of the content page 100 as a “widget.”)

The poll content may be pulled from a repository 708 which may include a plurality of poll questions managed by the content provider as described herein.

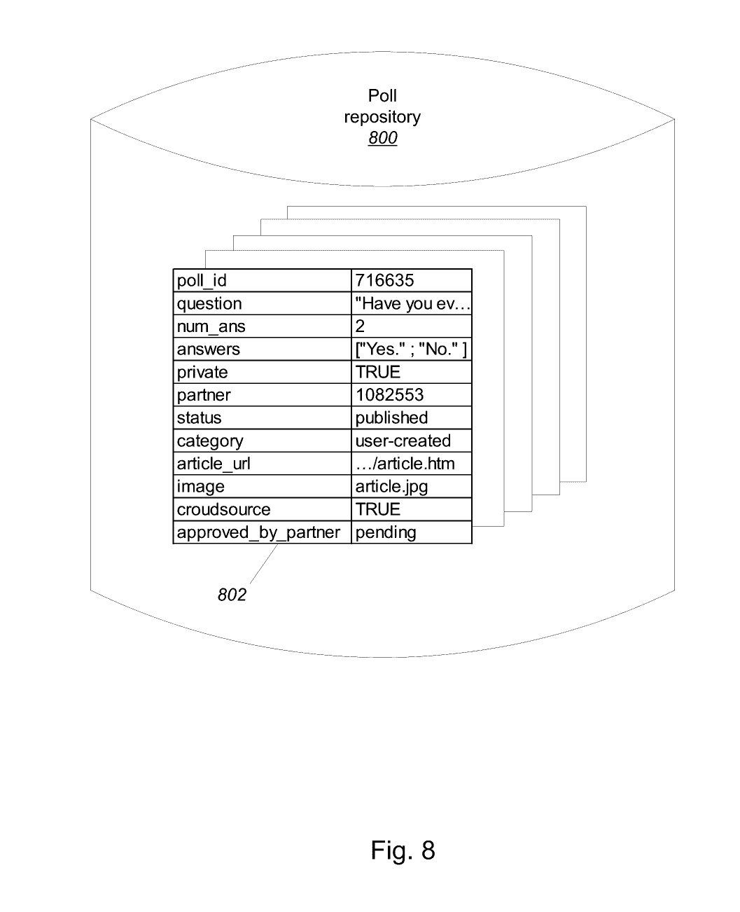

FIG. 8 illustrates a exemplary poll 802 which may be generated in response to a user-initiated poll question. The poll 802 is illustrated as a data structure stored in a repository 800 along with other polls. Each poll included in the repository may include a variety of different parameters which allows the system to select and serve polls, as well as allowing content managers to select and view polls.

As shown, the exemplary poll 802 may include a poll_id parameter which provides the primary indexing parameter for the repository 800. The poll_id may uniquely identify the poll, and in some implementations may be used to generate a custom URL for the poll as described further below.

The exemplary poll 802 further includes parameters associated with the substantive contents of the poll, namely a question parameter, a num_ans parameter (for the number of answers a user can select from), and an answers parameter which may include a list of answers. Although the exemplary poll 802 shows “answers” as a single parameter with a list of multiple values, it will be understood that in some implementations each answer may represent a separate parameter.

The exemplary poll 802 may further have parameters including the status of the poll on the network (that is, whether the poll should be treated as “private” by the system). The partner parameter can include the ID of the content creator associated with the content page where the poll was created. Where different categories of polls exist, a “user-created” category may designate polls created by users in this way. The URL associated with the article and an image associated with the article may both be included as parameters, along with a parameter marking the poll as a crowdsource poll.

Several values may be available for the approved_by_partner parameter. In some implementations, a “none” value for this parameter may be supplied when a user has not chosen to make the created poll available for publication by the publisher. Where the user has allowed the publisher access to the poll, a “pending” value may reflect that the poll is available for the partner to add to published polls but has not yet done so. Further values such as “approved” or “declined” may be used to reflect the content publisher's decision once it is made.

In conjunction with creating the record associated with the user-generated poll question 802, the system may return for the user a URL that includes both the associated content and an ID unique to the poll question (such as the poll_id). In the instant example show in FIG. 7, wherein the associated article_url is “www.example.com/article.htm,” the unique link given to the user might be “www.example.com/article.htm?poll_id=716635”.

At this point it should be noted that techniques in accordance with the present disclosure as described above may involve the processing of input data and the generation of output data to some extent. This input data processing and output data generation may be implemented in hardware or software. For example, specific electronic components may be employed in circuitry for implementing the functions in accordance with the present disclosure as described above. Alternatively, one or more processors operating in accordance with instructions may implement the functions in accordance with the present disclosure as described above. If such is the case, it is within the scope of the present disclosure that such instructions may be stored on one or more non-transitory processor readable storage media (e.g., a magnetic disk or other storage medium), or transmitted to one or more processors via one or more signals embodied in one or more carrier waves.

1. A computer-implemented method, comprising:
in response to a client request for content, selecting from a repository of poll questions at least one poll question associated with the requested content and providing to the requesting client the requested content, a poll allowing a user to respond to the at least one selected question, and a link that directs the user to a form for creating a poll question with a subject matter related to the content;
receiving from the client the poll question generated by the user, the poll question including at least a question associated with the content and a plurality of answers responsive to the question;
storing the received user-generated question in the repository of poll questions; and
in response to a subsequent request by a different client for the same content, selecting the user-generated question and providing to the different requesting client the requested content and a poll including the user-generated question.

2. The method of claim 1, further comprising:
receiving from the user permission for the user-generated question to be published;
submitting to a provider associated with the content the user-generated question; and
receiving from the provider approval to associate the user-generated question with the content in the repository;
wherein the user-generated question is provided to the different client based on it being associated with the content in the repository.

3. The method of claim 1, further comprising:
providing to the client a reference uniquely designating the user-generated question;
wherein the user-generated question is provided to the different client based on the client providing the reference as part of the request for the content.

4. The method of claim 3, further comprising:
before providing the user-generated question, determining that the different client is associated with a different user that is connected on a social network to the user that generated the question.

5. The method of claim 1, further comprising:
before providing the user-generated question, determining that the different client associated with a different user that is connected on a social network to the user that generated the question; and
providing the identity of the user that generated the question to the different client.

6. The method of claim 1, further comprising:
providing, along with the poll provided to the client, a reference to a form for submitting a poll question associated with the content;
wherein the user-generated poll question is received from the user selecting the reference and completing the form.

7. The method of claim 1, wherein the content comprises an article.

8. The method of claim 7, wherein the article comprises a news article.

9. A system for polling and sharing, comprising one or more processors configured to:
in response to a client request for content, select from a repository of poll questions at least one poll question associated with the requested content and provide to the requesting client the requested content, a poll allowing a user to respond to the at least one selected question, and a link that directs the user to a form for creating a poll question with a subject matter related to the content;
receive from the client the poll question generated by the user, the poll question including at least a question associated with the content and a plurality of answers responsive to the question;
store the received user-generated question in the repository of poll questions; and
in response to a subsequent request by a different client for the same content, select the user-generated question and provide to the different requesting client the requested content and a poll including the user-generated question.

10. The system of claim 9, wherein the one or more processors are further configured to:
receive from the user permission for the user-generated question to be published;
submit to a provider associated with the content the user-generated question; and
receive from the provider approval to associate the user-generated question with the content in the repository;
wherein the user-generated question is provided to the different client based on it being associated with the content in the repository.

11. The system of claim 9, wherein the one or more processors are further configured to:
provide to the client a reference uniquely designating the user-generated question;
wherein the user-generated question is provided to the different client based on the client providing the reference as part of the request for the content.

12. The system of claim 11, wherein the one or more processors are further configured to:
before providing the user-generated question, determine that the different client is associated with a different user that is connected on a social network to the user that generated the question.

13. The system of claim 9, wherein the one or more processors are further configured to:
before providing the user-generated question, determine that the different client associated with a different user that is connected on a social network to the user that generated the question; and
provide the identity of the user that generated the question to the different client.

14. The system of claim 9, wherein the one or more processors are further configured to:
provide, along with the poll provided to the client, a reference to a form for submitting a poll question associated with the content;
wherein the user-generated poll question is received from the user selecting the reference and completing the form.

15. The system of claim 9, wherein the content comprises an article.

16. The system of claim 15, wherein the article comprises a news article.

17. A non-transitory computer readable storage medium including instructions that, when executed by a processor, cause the processor to perform operations comprising:
in response to a client request for content, selecting from a repository of poll questions at least one poll question associated with the requested content and providing to the requesting client the requested content, a poll allowing a user to respond to the at least one selected question, and a link that directs the user to a form for creating a poll question with a subject matter related to the content;
receiving from the client the poll question generated by the user, the poll question including at least a question associated with the content and a plurality of answers responsive to the question;
storing the received user-generated question in the repository of poll questions; and
in response to a subsequent request by a different client for the same content, selecting the user-generated question and providing to the different requesting client the requested content and a poll including the user-generated question.

18. The non-transitory computer readable storage medium of claim 17, wherein the operations further comprise:
receiving from the user permission for the user-generated question to be published;
submitting to a provider associated with the content the user-generated question; and
receiving from the provider approval to associate the user-generated question with the content in the repository;
wherein the user-generated question is provided to the different client based on it being associated with the content in the repository.

19. The non-transitory computer readable storage medium of claim 17, wherein the content comprises an article.

20. The non-transitory computer readable storage medium of claim 19, wherein the article comprises a news article.
